(19) United States
(12) Patent Application Publication
(10) Pub. No.: US 2007/0241990 A1
(43) Pub. Date: Oct. 18, 2007

(54) METHOD FOR AUTOMATICALLY SWITCHING VIDEO SOURCES TO A DISPLAY DEVICE

(76) Inventors: Douglas L. Smith, Austin, TX (US); Henry Wurzburg, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/428,268

(22) Filed: Jun. 30, 2006

Related U.S. Application Data
(60) Provisional application No. 60/792,247, filed on Apr. 14, 2006.

(51) Int. Cl. G09G 5/00

(52) U.S. Cl. 345/5

(57) ABSTRACT

A system and method for automatically switching display of video signals between a first device and a second device. The system may include a display device with display circuitry for displaying an image on the display in response to a received video signal. The display device may include a first video input port for receiving a first video signal from the first device and a second video input port for receiving a second video signal from the second device. Additionally, the display device may include detection circuitry coupled to the second video input port for detecting the second video signal from the second device, and switch circuitry operable to automatically provide connectivity between the second video input port and the display circuitry to enable display of the second video signal in response to the detection circuitry detecting the second video signal from the second device.

### PRIORITY CLAIM

This application claims benefit of priority of provisional application Ser. No. 60/792,247 titled “Method for Automatically Switching USB Peripherals Between USB Hosts”, filed on Apr. 14, 2006, whose inventors are Henry Wurzburg, Steve Nelson, Mark Y. Fu, Hans Magnusson and Douglas L. Smith, and which is hereby incorporated by reference as though fully and completely set forth herein.

### BACKGROUND OF THE INVENTION

1. Field of the Invention

The present invention relates generally to display devices and, more specifically, to display devices with multiple inputs.

2. Description of the Related Art

In recent years, there has been a proliferation of devices that support video outputs to various displays, e.g., cathode ray tube (CRT) monitors, liquid crystal display (LCD) monitors, televisions (TVs), etc. For example, personal computers, portable computers, digital cameras/camcorders, personal video recorders (PVRs), portable music players, e.g., mp3 players, and others are able to produce video signals for display devices. As users begin to accumulate more of these devices, the demand for display devices which can display video signals produced by the devices increases. Correspondingly, it is often desired to share the video display or monitor between a plurality devices.

Currently, this requires manually exchanging the video cables from the devices to the display device. Alternatively, KVM switches exist which provide manually actuated cabling switches. Video Conference Pods also exist, whereby, when a computer video signal is attached, the unit will switch from the video conference display to displaying the computers output. However, this is accomplished by the manually switching the video sources. Thus, current solutions require the user to either press a switch or detach and re-attach video cables.

### SUMMARY OF THE INVENTION

One embodiment of the invention provides an easy, intuitive system and method for automatically switching video connectivity of a display device between at least two video (source) devices based on respective connectivity of the video devices. For example, the method may be used where video output signals from one video device are usually displayed and are automatically switched to display output signals from a second video device when the second device is attached to the system.

An exemplary system may comprise a display device, a first device (e.g., a desktop computer system) coupled to the display device, and a second video device (e.g., a video peripheral device) that may be selectively coupled to the display device. The display device may be any of various display devices. For example, in one embodiment, the display device may be a CRT or LCD monitor or a TV, e.g., a CRT, LCD, or plasma TV, among other display devices. Alternatively, the display device may be a portable or handheld display device. Thus, according to one embodiment, the display device may be any appropriate device usable to display video signals.

In one embodiment, the display device may include a display, display circuitry for displaying an image on the display in response to received signals, switching circuitry, and detection circuitry. Additionally, the display device may include a plurality of video ports for receiving video signals from the devices. In one embodiment, the display device may include a first video port for receiving video from the first device and a second video port for receiving video from the second device.

The plurality of video ports may each be associated with or coupled to one or more interfaces. For example, in one embodiment, the plurality of ports may include one or more VGA interfaces, one or more component video interfaces, one or more composite video interfaces, one or more digital visual interfaces (DVIs), one or more HDMIs, one or more unified display interfaces (UDIs), one or more DisplayPort interfaces, one or more digital flat panel (DFP) interfaces, one or more universal serial bus (USB) interfaces, one or more FireWire interfaces, one or more co-axial interfaces, one or more separate-video (S-video) interfaces, one or more RCA interfaces, one or more BNC interfaces, one or more red green blue (RGB) interfaces, one or more radio frequency (RF) interfaces, and/or one or more infra-red (IR) interfaces, among others.

The video signals from the second video device may be automatically displayed on the display device when attached or docked, and the video output signals from the primary host may be automatically disconnected from the display circuitry of the display device. This automatic switching may reduce or eliminate a manual procedure, e.g., whereby the user must manually switch cables or invoke a switching mechanism, e.g., via a button or hotkey. This embodiment allows, for example, for video signals from a semi-permanently attached notebook docking station to be automatically switched onto the display when the notebook is inserted into the dock. In other words, the display device may switch from displaying video signals of the computer system to displaying video signals from the notebook computer/docking station. Alternatively, a video media player's video is automatically displayed on a monitor when the media player is attached, instead of the semi-permanently attached desktop computer system's video, without detaching the computer system's video cable or manually actuating a switch on the monitor.

In this embodiment, the display device may include two input sources, one for the first video device and one for the secondary video device. The display device may detect when the second video device is attached and automatically switch to displaying the output from the second video device via electronic internal switching. Detection of the second video device may vary depending on the display interface. For example, video graphics adaptor (VGA) analog may be detected by sync signal activity on the secondary connector. High-definition multimedia interface (HDMI) signals have an electrical “hot plug” signal that may be detected when the video device is attached. Other methods may be used for other types of video signals. Since a display device usually only accommodates one type of interface/port, it may be relatively simple to detect attachment for the interface/port.

However, in some embodiments, as indicated above, the display device may include a plurality of ports and/or associated interfaces. Thus, the display device may detect video signals from one or more of the plurality of video devices and automatically switch to displaying signals from the one or more video devices. Said another way, similar to above, when a device, e.g., the second device, is coupled to, or initialized (e.g., turned on) with respect to video signals transmitted to the display device, the display device may be operable to automatically switch from receiving video signals from another device, e.g., the first video device, to receiving signals from the device. As indicated above, the display device may utilize various methods for detecting the presence or initiation of video signals from each of the plurality of devices, e.g., depending on the port/interface used for the device.

In some embodiments, as indicated above, the video devices, e.g., the first video device and the second video device, may be any of various video devices. For example, the video devices may include a desktop computer system, a portable computer (e.g., a notebook computer), and/or a docking station coupled to the portable computer. In some embodiments, the video devices may include video recorders, e.g., personal video recorders (PVRs), digital video recorders (DVRs), camcorders, etc., and/or portable music players, e.g., mp3 players, which may include various video outputs for displaying music videos, music visualizers, menus, or other outputs. Note that the video devices may include any appropriate video devices and is not limited to the above descriptions. Thus, various video devices may be coupled to the display device, which may automatically switch between the devices.

### BRIEF DESCRIPTION OF THE DRAWINGS

A better understanding of the present invention may be obtained when the following detailed description is considered in conjunction with the following drawings, in which:

FIG. 1 is a block diagram of an exemplary display device that automatically switches from a primary host video source to a secondary host video source upon attachment of the secondary host according to one embodiment

FIGS. 2 and 3 illustrate exemplary systems according to one embodiment; and

FIG. 4 is a flowchart describing one embodiment of a method for controlling switching of video displays for a display device.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (e.g., having the potential to or being able to in some embodiments), not a mandatory sense (i.e., must). The term “include”, and derivations thereof, mean “including, but not limited to”. The term “coupled” means “directly or indirectly connected”.

### DETAILED DESCRIPTION OF EMBODIMENTS OF THE INVENTION

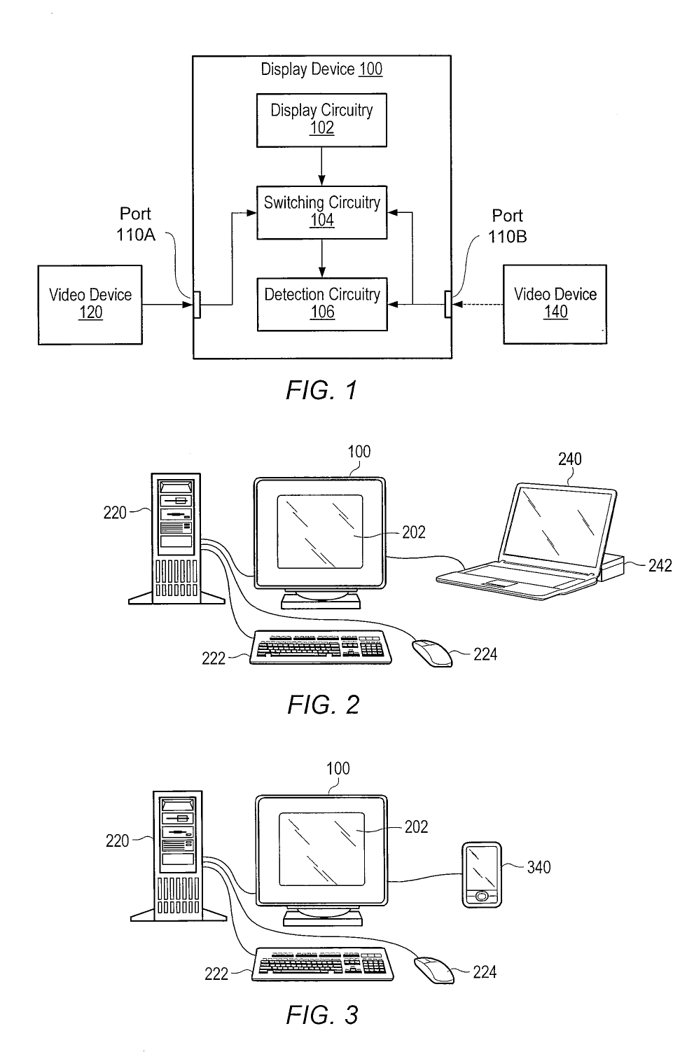

### FIG. 1—Exemplary Display Device and Coupled Video Devices

FIG. 1 illustrates an exemplary display device 100 which provides an easy, intuitive system and method for automatically switching video connectivity between a plurality of video (source or output) devices based on respective connectivity of the video devices. As shown, the system may include the display device 100, a first video device 120 (e.g., a host device such as a desktop computer system) coupled to the display device 100, and a second video device 140 (e.g., a peripheral video device) that may be selectively coupled to the display device 100. The display device 100 may be any of various display devices. For example, in one embodiment, the display device 100 may be a CRT or LCD monitor, or a TV, e.g., a CRT, LCD, or plasma TV, among other display devices. Alternatively, the display device 100 may be a portable or handheld display device. Thus, the display device 100 may be any appropriate device usable to display video signals.

In one embodiment, the display device 100 may include a display (e.g., display 202 shown in FIG. 2), display circuitry 102 for displaying an image on the display in response to received signals, switching circuitry 104, and detection circuitry 106 which will be described in more detail below. Additionally, the display device 100 may include a plurality of video ports 110 (e.g., port 110A and/or port 110B) for receiving video signals from a plurality of devices. In one embodiment, the display device 100 may include a first video port 110A for receiving video from the first device 120 and a second video port 110B for receiving video from the second device 140.

In some embodiments, the plurality of video ports 110 may each include or couple to one or more interfaces. For example, in one embodiment, the plurality of ports 110 may include one or more VGA interfaces, one or more component video interfaces, one or more composite video interfaces, one or more digital visual interfaces (DVIs), one or more HDMIs, one or more unified display interfaces (UDIs), one or more DisplayPort interfaces, one or more digital flat panel (DFP) interfaces, one or more universal serial bus (USB) interfaces, one or more FireWire interfaces, one or more co-axial interfaces, one or more separate-video (S-video) interfaces, one or more RCA interfaces, one or more BNC interfaces, one or more red green blue (RGB) interfaces, one or more radio frequency (RF) interfaces, and/or one or more infra-red (IR) interfaces, among others.

In some embodiments, the display device 100 may include the detection circuitry 104 associated with/coupled to the plurality of ports 110. For example, the display device may use the detection circuitry 104 to detect when the second video device 140 is attached (and/or activated) and automatically switch to displaying the output from the second video device 140 via electronic internal switching, e.g., the switching circuitry 106. More specifically, in some embodiments, the detection circuitry 104 may detect when the second device is coupled and provide an output to the switching circuitry 106. Upon receiving an output from the detection circuitry 104, the switching circuitry 106 may automatically switch the respective video input signal from the second device 140 to be processed by the display circuitry 102. Automatically switching the video input signals may involve disconnecting the original video source from the display circuitry 102, e.g., the first device 120, and connecting the new video source, e.g., the second device 140, to the display circuitry 102.

Said another way, the video signals from the second video device 140 may be automatically displayed to the display device 100 when attached, e.g., to one of the video ports 110, or docked, e.g., into a docking station coupled to the display device 100. The primary host, e.g., the first device 120, disconnected, thereby reducing or eliminating a manual procedure, e.g., whereby the user must manually switch cables or invoke a switching mechanism, e.g., via a button or hotkey. More specifically, the display device 100 may switch from displaying signals from the first device 120 to the second device 140 without any direct input other than video signals being received from the second device 140. Thus, in one embodiment, a user may simply plug in a device and see video signals from the device on the display 202 of the display device 100.

As used herein, the term “direct user input” refers to input from a user specifying the specific action to be performed. For example, direct user includes the manual procedure described above, where the user must manually switch cables or invoke a switching mechanism, e.g., via a button or physical switch. However, it should be noted that plugging in a video device, e.g., into the display device 100, does not constitute direct user input. In other words, as described herein, the display device 100 may automatically switch video signal sources when the user plugs in a video device and may not require any further action of the user to invoke the switching.

This embodiment allows, for example, for video signals from a semi-permanently attached notebook docking station to be automatically switched onto the display when the notebook is inserted into the dock. In other words, the display device may switch from displaying video signals from the computer system to displaying video signals from the notebook computer/docking station. Alternatively, a video media player's video may be automatically displayed on the display device 100 when the media player is attached, instead of the semi-permanently attached desktop computer system's video, without detaching the computer system's video cable or manually actuating a switch on the monitor.

In other words, when the display device 100 detects that the second device 140 is sending video signals (e.g., via the detection circuitry 106 detecting receipt of video signals from the second device 140) the switching circuitry 104 may operate to route the received video signals from the second device 140 to the display circuitry 102. This causes display of the output from the second device 140 via electronic internal switching. As indicated above, the automatic switching described herein does not require any “direct user input” to perform the switch as defined above, rather the user merely connects and/or activates the secondary video source to the respective input port of the display device.

In some embodiments, instead of switching the entirety of the display 102 from video signals of the first device 120 to video signals of the second device 140, the display device 100 may display the video signals from the second device 140 on a portion the display 102 and display the video signals from the first device 120 on another portion of the display 102. In one embodiment, the video signals from the second device 140 may be displayed as a “picture in picture” display. In other words, the video signals from the second device 140 may take up a small portion of a corner of the display 102 and overlay the video signals from the first device 120 which may take up the remainder of the display 102. However, it should be noted that multiple layouts are envisioned; in other words, the layouts are not limited to those described above. For example, in some embodiments, the user may be able to select the portion of the display 102 that corresponds to the video signals from the second device 140 in order to view the video signals from the second device 140 on a larger portion of the display 102, e.g., the entirety of the display 102. Alternatively, or additionally, the user may be able to resize or change the location of the portions of the display representing video signals from the first and second devices. Note however, that no “direct user input” is required to invoke the automatic display of the video signals from the second device 140 on the display 102. Thus, in some embodiments, the automatic display of video signals from the second device 140 may only be a portion of the display 102 of the display device 100.

In some embodiments, detection of the second device 140, e.g., using the detection circuitry 106, may vary depending on the display interface. For example, video graphics adaptor (VGA) analog may be detected by sync signal activity, e.g., transitions detected on the sync signals, on the port by which the device is attached to the display device 100. High-definition multimedia interface (HDMI) signals have an electrical “hot plug” signal that may be detected when the device is attached. Activity of composite interfaces may be detected by monitoring the DC level of the inputs for a common mode shift, which may indicate an attachment of a video device. Other methods may be used for other types of video signals. Since a display device usually only accommodates one or a few types of port/interface, it may be relatively simple to detect attachment of video devices.

However, in some embodiments, as indicated above, the display device 100 may include a plurality of ports and/or associated interfaces (e.g., for more than two video devices). Thus, the display device may detect video signals from one or more of the plurality of video devices and automatically switch to displaying signals from the one or more video devices. Said another way, similar to above, when a device of the plurality of devices is coupled to, or initialized (e.g., turned on) with respect to video signals transmitted to the display device 100, the display device 100 may be operable to automatically switch from receiving video signals from another device to receiving signals from the device. Thus, in some embodiments, three or more devices may be coupled to the display device 100.

For example, in one embodiment, a first device, e.g., a computer system, may be coupled to the system, and the user may activate or couple a second device, e.g., a laptop, to the display device 100. In this example, the display device 100 may automatically switch to displaying video signals from the second device. As described above, the video signals from the second device may take up the entirety or a portion of the display 102. As also indicated above, the user may have the ability to choose which portion or the placement/size of the portion of the display 102 that the signals from the first and/or the second device takes. In other words, the user may be able to change the size or the location of the portions of the display 102 that the video signals from the first device and the second device use.

Additionally, the user may connect or activate a third device, e.g., a video media player. In some embodiments, video signals from the third device may be automatically displayed on the display device. In one embodiment, the video signals from the third device may be displayed in conjunction with video signals from the first and/or the second device(s). In this embodiment, similar to descriptions above, the user may be able to resize/change the portions of the display that are allocated to the first, second, and/or third devices. Alternatively, the display device 100 may simply display the video signals from the third device using the entirety of the display 102. In another embodiment, video signals from the second and third devices may take up a “split-screen” layout; in other words the second and third devices may share the display 102 of the display device 100. As indicated above, the display device 100 may utilize various methods for detecting the presence or initiation of video signals from each of the plurality of devices, e.g., depending on the port/interface used for the device. Thus, the display device 100 may support multiple layouts and display modes as well as three or more coupled devices.

In some embodiments, the display device 100 may also detect, e.g., using the detection circuitry 106, when the second device 140 is removed, or when its signals are no longer being sent to the display device 100. The display device, e.g., using the switching circuitry 104, may then automatically provide connectivity between the first device 120 and the display circuitry 102, thereby allowing the user to view the video signals from the first device 120. Similar to above, the switching circuitry may disconnect the second device 140 from the display circuitry 102 before, during, or after providing the connectivity of the first device 120. Thus, the user may view signals from a first device, connect a (or turn on already coupled) second video device to the display device 100, automatically view video signals from the second device, and disconnect (or turn off) the second video device to view video signals from the first device 120.

Note that the descriptions above regarding the disconnection or deactivation of the second device also apply equally well to embodiments where more than two devices may be coupled to the display device 100. Thus, when there are three or more devices, when an active device is disconnected, the user may view the first device, or a previously displayed device. Alternatively, or additionally, the user may be able to resize, move location of, or choose which video signals should be displayed on the display 102. Thus, the display device may detect disconnection or deactivation of devices and automatically switch to displaying video signals from one or more other devices.

Note also that in some embodiments, the video devices may be directly attached to the display device 100; however, in alternate embodiments, the video devices may be coupled to the display device 100 indirectly. For example, in one embodiment, one or more of the devices may be coupled to the computer system which may act as a proxy for the display device 100. In other words, the video devices may be coupled to the display device 100 via a variety of methods and are not limited to the couplings described above.

In some embodiments, as indicated above, the video devices, e.g., the first video device 120 and the second video device 140, may be any of various video devices. For example, the video devices may include a desktop computer system, a portable computer (e.g., a notebook computer), and/or a docking station coupled to the portable computer. In some embodiments, the video devices may include video recorders, e.g., personal video recorders (PVRs), digital video recorders (DVRs), camcorders, etc., and/or portable music players, e.g., mp3 players, which may include various video outputs for displaying music videos, music visualizers, menus, or other outputs. Note that the video devices may include any appropriate video devices and is not limited to the above descriptions. Thus, various video devices may be coupled to the display device, which may automatically switch between the various devices.

### FIGS. 2 and 3—Exemplary Display Device

FIGS. 2 and 3 illustrate one embodiment of the display device 100 which is operable to automatically switch video connectivity between at least two video sources. As shown in FIG. 2, the display device 100 may be coupled to a computer system 220 which may include or couple to input devices such as, for example, keyboard 222 and mouse 224. Additionally, a notebook computer 240 and/or a docking station 242 of the notebook computer 240 may be coupled to the display device 100. Thus, as indicated above, the first device 120 may be a computer system, e.g., the computer system 220, and the second device 140 may be a notebook computer, e.g., the notebook computer 240, possibly with the docking station 242.

Turning now to FIG. 3, a video media player 340 may be coupled to the display device 100, instead of, or in conjunction with, the laptop 240 and/or other devices that may be coupled to the display device 100. Thus, as described above, when device(s), e.g., the notebook computer 240, the video media player 340, and/or other devices, such as those described above, among others, are coupled or begin transmitting signals to the display device 100, the display device 100 may automatically switch and display video signals from the device(s).

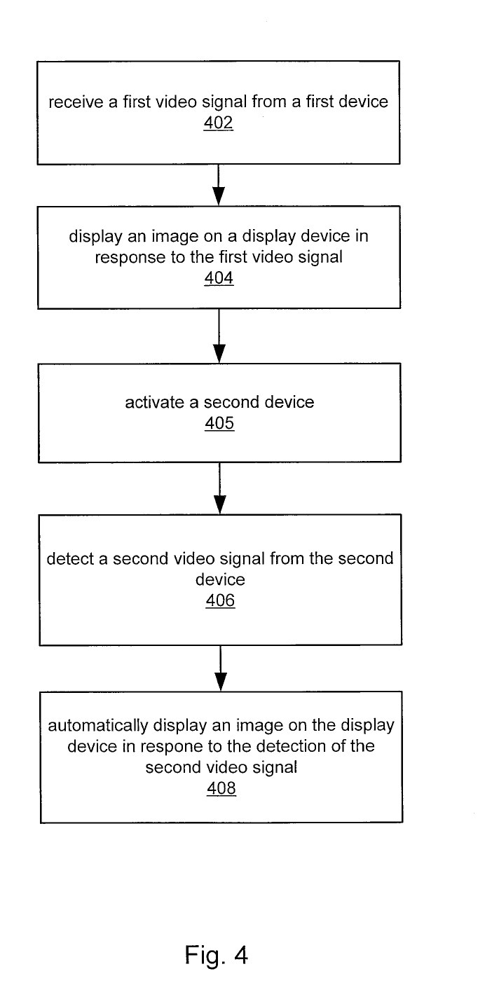

### FIG. 4—Flowchart of a Method for Controlling Switching for a Display Device

FIG. 4 illustrates a method for controlling switching for a display device, such as, for example, the display device 100 described above. Note that the method shown in FIG. 4 may be used in conjunction with any of the systems or devices shown in the above Figures, among other systems or devices. In various embodiments, some of the method elements shown may be performed concurrently, in a different order than shown, or may be omitted. Additional method elements may also be performed as desired. As shown, this method may operate as follows.

In 402, a first video signal may be received from a first device. As described above, the video signal may be received by the display device for displaying the video signal to a user. As also described above, the display device may be any of numerous appropriate display devices, e.g., CRTs, LCDs, TVs, portable display devices, etc., and the first device may be any of numerous video devices, e.g., computer systems, portable computer systems, video recorders, video media players, or other video devices. Additionally, the display device may support a plurality of different types of ports and/or interfaces, such as those described above, among others. Thus, video signals may be received by a first device.

In 404, an image may be displayed on the display device in response to the first video signal. More specifically, the display device may display the video signals received from the first device on a display of the display device, e.g., using display circuitry.

In 405, a second device may be activated. In some embodiments, the second device may be activated by the user connecting the second device to the display device. Alternatively, the second device may already be coupled to the display device, e.g., directly or via an intermediary device, e.g., a docking station. In this embodiment, the second device may be activated by turning on the second device, or by initializing the second device, e.g., such that it begins to transmit video signals to the display device. For example, where the device is a laptop computer, the laptop computer may be activated by coupling the laptop computer the display device, docking the laptop computer into a dock station coupled to the display device, or turning on or “waking up” the laptop computer where it is already coupled to the display device, among other methods. “Waking up” the laptop computer may include pressing one or more buttons on the laptop or otherwise specifying that the computer enter normal operation modes (e.g., from a sleeping mode), e.g., via an input device such as a mouse or keyboard. Thus, the second device may be activated via a variety of methods.

In 406, a second video signal may be detected from a second device. Similar to above, the second device may be any of the appropriate devices described herein, among others. In some embodiments, detection circuitry of the display device may detect when the video signals are received from the second device and send an indication to switching circuitry in the display device in response to the detection of the video signals. Thus, the display device may detect when signals are received from the second video device.

In 408, an image corresponding to the second video signal may be automatically displayed on the display device in response to the detection of the second video signal. In some embodiments, the display device may simply display the video signals received from the second device on the display of the display device, thereby allowing a user to view the video signals transmitted by the second device. The display device may automatically switch to displaying signals from the second device without any direct user input specifying the switch. Thus, when a user connects the second device, or, for example, turns on or initiates the second device such that it begins transmitting video signals to the display device, the display device may automatically switch from displaying video signals from the first device to displaying video signals from the second device. As described above, this may eliminate the tedious procedure of switching cables or requiring that the user press various manual switches or buttons to invoke such switching.

In some embodiments, as also indicated above, the method may include detecting when the second device stops sending video signals to the display device, and in response to the detection, automatically displaying signals from the first device. Thus, when a user plugs in or initiates a second device, the display device may automatically show the user signals from the second device. Then, when the user no longer needs to view the second device, the user may deactivate or unplug the second device, and the display device may automatically display video signals received by the first device. Thus, the user may easily and intuitively switch between a first device and a second device.

Additionally, similar to above, the display device may support more than two devices plugged into the display device. Thus, when new display devices are activated/deactivated, the display device may react accordingly, allowing the user to easily view any of the numerous display devices as desired.

Thus, a display device may automatically switch between a plurality of video devices without direct user input specifying the switch.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A display device, comprising:
a display;
display circuitry for displaying an image on the display in response to a received video signal;
a plurality of video ports for receiving video signals from devices, comprising:
a first video input port for receiving a first video signal from a first device; and
a second video input port for receiving a second video signal from a second device;
detection circuitry coupled to the second video input port for detecting the second video signal from the second device; and
switching circuitry coupled to the detection circuitry, the display circuitry, the first video input port and the second video input port;
wherein the switching circuitry is operable to automatically provide connectivity between the second video input port and the display circuitry to enable display of the second video signal in response to the detection circuitry detecting the second video signal from the second device.

2. The display device of claim 1, wherein the switching circuitry is operable to automatically provide connectivity without direct user input specifying switching of the connectivity.

3. The display device of claim 1, wherein the switching circuitry is operable to disconnect the first device before providing connectivity between the display circuitry and the second device.

4. The display device of claim 1, wherein the detection circuitry is further operable to detect when the second video signal from the second devices ceases, and wherein the switching circuitry is further operable to automatically provide connectivity between the first video input port and the display circuitry to enable display of the first video signal in response to the detection circuitry detecting the second video from the second device has ceased.

5. The display device of claim 1, wherein the first device is a host device.

6. The display device of claim 1, wherein the second device is a peripheral video device.

7. The display device of claim 1, wherein the first video input is operable to couple to a host computer.

8. The display device of claim 1, wherein the second video input port is operable to couple to a portable computer.

9. The display device of claim 8, wherein the detection circuitry is operable to detect the second video source when the portable computer is docked in a docking station coupled to the display device.

10. The display device of claim 1, wherein the display device further comprises one or more interfaces, wherein the plurality of ports each couple to the one or more interfaces, wherein the one or more video interfaces comprise one or more of:
one or more video graphics adapter (VGA) interfaces;
one or more component video interfaces;
one or more composite video interfaces;
one or more digital visual interfaces (DVIs);
one or more high-definition multimedia interfaces (HDMIs);
one or more unified display interfaces (UDIs);
one or more DisplayPort interfaces;
one or more digital flat panel (DFP) interfaces;
one or more universal serial bus (USB) interfaces;
one or more firewire interfaces;
one or more co-axial interfaces;
one or more separate-video (S-video) interfaces;
one or more RCA interfaces;
one or more BNC interfaces;
one or more red green blue (RGB) interfaces;
one or more radio frequency (RF) interfaces; or one or more infra-red (IR) interfaces.

11. A method of operating a display device, comprising:
receiving a first video signal from a first device;
displaying an image on the display device in response to the first video signal;
detecting a second video signal from a second device; and
automatically displaying an image on the display device in response to said detecting the second video signal from the second device.

12. The method of claim 11, wherein said automatically displaying is performed without direct user input specifying said automatically displaying the second video signal

13. The method of claim 11, wherein the display device comprises display circuitry for displaying images on the display device; and
wherein said automatically displaying comprises automatically switching connectivity between the first video signal and the display circuitry to between the second video signal and the display circuitry in response to said detecting the second video signal from the second device.

14. The method of claim 13, wherein said automatically displaying is performed without direct user input specifying said automatically switching.

15. The method of claim 11, wherein the first device is a host device.

16. The method of claim 11, wherein the second device is a peripheral video device.

17. The method of claim 11, wherein the first device is a host computer.

18. The method of claim 11, wherein the second device is a portable computer.

19. A system, comprising:
means for receiving a first video signal from a first device;
means for displaying an image on the display device in response to the first video signal;
means for detecting a second video signal from a second device; and
means for automatically displaying an image on the display device in response to the second video signal in response to said detecting the second video signal from the second device.
